(19) United States
(12) Patent Application Publication
(10) Pub. No.: US 2025/0229631 A1
(43) Pub. Date: Jul. 17, 2025

(54) Apparatus and Method for Visualising an Interaction of a Physical Object with a 3D Image, and Motor Vehicle Having the Apparatus

(71) Applicant: Bayerische Motoren Werke Aktiengesellschaft, Muenchen (DE)

(72) Inventor: Alexander Peters, Muenchen (DE)

(21) Appl. No.: 18/851,009

(22) PCT Filed: Feb. 8, 2023
(86) PCT No.: PCT/EP2023/053105

§ 371 Date: Sep. 25, 2024

(30) Foreign Application Priority Data
Apr. 27, 2022 (DE) 10 2022 110 162.2

(51) Int. Cl. B60K 35/28; G06F 3/01; G06V 40/10; G06V 40/20

(52) U.S. Cl. CPC B60K 35/28; G06F 3/011; G06F 3/017; G06V 40/10; G06V 40/28; B60K 2360/1464; B60K 2360/29; B60K 2360/31; B60K 2360/334; B60K 2360/741

(57) ABSTRACT

An apparatus for visualizing an interaction of a physical object with a 3-D image includes a display device, a first projection device, an acquisition device, and an evaluation device. The display device presents the 3-D image which is perceivable by a user. The first projection device projects a first optical display onto a first region of the physical object. The acquisition device captures first object data of the display device and second object data of the physical object that is spaced apart from the display device and movable. The acquisition device determines a distance between a reference position formed on a surface of the display device and the physical object using the first object data and the second object data. The evaluation device is signal-connected to the acquisition device and the first projection device, and triggers the projection of the first optical display by the first projection device responsive to a condition in which the determined distance is less than a minimum distance defined in advance.

The present application is the U.S. national phase of PCT Application PCT/EP2023/053105 filed on Feb. 8, 2023, which claims priority of German patent application No. 10 2022 110 162.2 filed on Apr. 27, 2022, the entire contents of which are incorporated herein by reference.

### TECHNICAL FIELD

The present disclosure relates to an apparatus and a method for visualizing an interaction of a physical object with a 3-D image, and to a motor vehicle having the apparatus.

### BACKGROUND

Various techniques for presenting 3-D images are known. In this context, it is possible to distinguish between techniques that require auxiliary means such as 3-D glasses and techniques in which a 3-D image can be perceived three-dimensionally by an observer without auxiliary means. For example, autostereoscopy and holography are included among the latter techniques. In contrast with images, 3-D images have depth 2-D information in this case, whereby an object presented in 3-D can be better illustrated. By now, the observation of a 3-D image from several sides has been rendered possible from a technical point of view. It is also possible to move a 3-D image in space, for example rotate or tilt the latter. This can be achieved by appropriate software that is also used to present the 3-D image. A direct interaction of a tangible body with the 3-D image is not directly possible. However, a sensor-based capture of the tangible body and a merging of the 3-D image with the data captured by sensors by means of software can simulate an interaction between the 3-D image and the tangible body, whereby this interaction can be rendered visible on an electronic visual display, for example. Thus there is a need for better visualization of an interaction between a 3-D image and a physical body.

There is a need, therefore, for providing an apparatus and/or method that allows improved visualization of an interaction between a physical object and a 3-D image.

### SUMMARY

The above-described need, as well as others, are addressed by one or more embodiment discussed herein.

A first aspect of the disclose relates to an apparatus for visualizing an interaction of a physical object, in particular a hand, with a 3-D image, comprising: (i) a display device configured to present a 3-D image which is perceivable by a user; (ii) a first projection device configured to project a first optical display onto a first region of the physical object; (iii) an acquisition device configured to capture first object data of the display device and second object data of the physical object that is spaced apart from the display device and movable, and wherein (iv) the acquisition device is configured to determine a distance between a reference position formed on a surface, in particular centrally on the surface, and further particularly on a surface facing the 3-D image, of the display device and the physical object using the first object data and the second object data; (v) an evaluation device signal-connected to the acquisition device and the first projection device, and (vi) wherein the evaluation device is configured to trigger a projection of the first optical display by the first projection device should the determined distance be less than a minimum distance defined in advance.

The terms “comprises”, “contains”, “includes”, “features”, “has”, “with” or any other variant thereof as may be used herein are intended to cover non-exclusive inclusion. By way of example, a method or an apparatus that comprises or has a list of elements is thus not necessarily limited to those elements, but may include other elements that are not expressly listed or that are inherent to such a method or such an apparatus.

Furthermore, unless expressly stated otherwise, “or” refers to an inclusive “or” and not to an exclusive “or”. For example, a condition A or B is satisfied by one of the following conditions: A is true (or present) and B is false (or absent), A is false (or absent) and B is true (or present), and both A and B are true (or present). The terms “a” or “an” as used here are defined in the sense of “one or more”. The terms “another” and “a further” and any other variant thereof should be understood in the sense of “at least one other”.

The term “plurality” as used here should be understood in the sense of “two or more”.

For the purposes of the disclosure, the term “configured” or “designed” to fulfil a particular function (and any variations thereof) is understood to mean that the corresponding apparatus is already present in a configuration or setting in which it can perform the function or is at least adjustable—i.e. configurable—such that it can perform the function after appropriate adjustment. The configuration can be applied, for example, by an appropriate setting of parameters of a process sequence or of switches or similar for activating or deactivating functionalities or settings. In particular, the apparatus may comprise multiple predetermined configurations or operating modes, SO that the configuration can be carried out by means of a selection of one of these configurations or operating modes.

For the purposes of the disclosure, the term “3-D image” is understood to mean, in particular, a representation which is visually perceivable by an observer and which can be perceived in three dimensions by the observer.

For the purposes of the disclosure, a “3-D image sensor” is understood to mean, in particular, an image sensor, in particular a 3-D camera, capable of capturing a scene in three spatial dimensions by means of sensors such that, in particular, the measurement of distances or spacings in the scene is rendered possible in the process.

For the purposes of the disclosure, a “distance” is understood to mean, in particular, a spatial extent between two points or objects in three-dimensional space.

For the purposes of the disclosure, the term “optical signals” is understood to mean, in particular, electromagnetic signals that are perceivable by the human eye.

For the purposes of the disclosure, a “physical object” is understood to mean any object formed from matter.

A visualization of an interaction of the physical object with the 3-D image can be achieved by the apparatus according to the first aspect. What can also be achieved is that a projection is triggered only when the determined distance is less than a minimum distance defined in advance. The defined minimum distance allows a determination of the distance between the physical object and the display apparatus from which there should be a projection of a first optical display. In this case, the minimum distance can be defined in such a way that the physical object at least partially overlaps with a position of the 3-D image when this minimum distance is undershot.

Preferred embodiments of the apparatus will now be described below, each of which, unless expressly excluded or technically impossible, may be combined as desired with one another and with the other aspects also described.

In some embodiments, the acquisition device is configured to determine the distance continually in real time. A timely trigger of the projection of the first display when the minimum distance is undershot can be achieved thereby. As a result, there is an even better visualization of the interaction, as it is implemented with the movement of the physical object.

In some embodiments, the evaluation device is configured to determine a movement direction of the physical object in relation to the display device in real time using the continually determined wherein distance, the first optical display represents the movement direction of the physical object, in particular by way of a displayed arrow. This displays the movement direction on the physical object in addition to the visualization of the interaction, whereby the visualization of the interaction is improved further.

In some embodiments, the evaluation device is configured to trigger a projection of the first optical display, representing the movement direction, continually over a predetermined time interval, wherein the first optical display changes over the time interval. As a result, a time-varying optical display, i.e. a moving display, can be presented on the physical object over the predetermined time interval, in particular over a few seconds, in particular over 1 to 5 seconds. This improves the signaling effect of the projection, whereby the visualization is improved further.

In some embodiments, the acquisition device is configured to determine a rotational position of the physical object in relation to an initial position, defined in advance, using the second object data of the physical object and trigger, basis of the rotational position, a presentation of the first optical display. As a result, a projection can be triggered if the physical object is rotated. Especially if the physical object is the hand, a projection can be triggered if the hand rotates in such a way that the acquisition device initially captures a palm of the hand, which may correspond to the defined initial position, and a back of the hand is captured after the rotation. This provides an additional option whereby a projection can be triggered.

In some embodiments, the acquisition device is signal-connected to the display device, wherein the acquisition device is configured to trigger, on the basis of the determined distance and/or the rotational position of the physical object, a change in the presentation of the 3-D image by the display device. The capability of triggering a change in the presentation of the 3-D image when the physical object approaches the 3-D image is rendered possible hereby. The acquisition device can trigger a change in the 3-D image by the display device should the distance be less than the minimum distance defined in advance. Likewise, a change in the 3-D image, in particular a rotation of the 3-D image, can be brought about by a change in the rotational position of the physical object. Advantageously, this can visualize the interaction by the projection, and a change in the 3-D image can additionally be brought about.

In some embodiments, the acquisition device is configured to trigger, on the basis of the determined movement direction of the physical object, change in the presentation of the 3-D image by the display device. As a result, a change in the 3-D image can be coupled to the movement direction of the physical object, whereby a change in the 3-D image is achieved by way of a movement. This improves the interaction between the physical object and the 3-D image.

In some embodiments, the display device is configured to present the 3-D image in autostereoscopic or holographic fashion. This allows the user to perceive the 3-D image without additional auxiliary means, such as 3-D glasses.

In some embodiments, the apparatus comprises a second projection device configured to project a second optical display onto a second region of the physical object, wherein the evaluation device is configured to trigger the second projection should the determined distance be less than the minimum distance defined in advance. This can ensure that at least one projection on the physical object is sufficiently visible. Furthermore, improved visualization of the interaction can be made possible.

A second aspect relates to a motor vehicle, comprising an apparatus according to the first aspect.

A third aspect relates to a method, in particular a computer-implemented method, for visualizing an interaction of a physical object with a 3-D image, including the following steps: (i) presenting t image by a display device, wherein the 3-D image is perceivable by a user; (ii) capturing first object data of the display device and second object data of the physical object that is spaced apart from the display device and movable; (iii) determining a distance between a reference position formed on a surface, in particular centrally on the surface, and further particularly on a surface facing the 3-D image, of the display device and the physical object using the first object data and the second object data; and (iv) projecting an optical display onto a region of the physical object should the determined distance be less than a minimum distance defined in advance.

The features and advantages explained in relation to the first aspect of the disclosure also apply correspondingly to the further aspects.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 schematically shows an apparatus according to a first exemplary embodiment of the disclosure, having a projection device;

FIG. 2 schematically shows an apparatus according to a second exemplary embodiment of the disclosure, having three projection devices;

FIG. 3A schematically shows a 3-D representation of a hand, a 3-D image, and a display apparatus;

FIG. 3B schematically shows a different 3-D representation of a hand, a 3-D image, and a display apparatus;

FIG. 4A schematically shows a hand moving away from a 3-D image;

FIG. 4B schematically shows a hand moving toward a 3-D image;

FIG. 5A schematically shows an overlap of a hand with a 3-D image to a first extent of the area of said hand;

FIG. 5B schematically shows an overlap of a hand of with a 3-D image to a second extent of the area of said hand;

FIG. 5C schematically shows an overlap of a hand with a 3-D image to a third extent of the area of said hand;

FIG. 6 schematically shows a hand which moves in translational and/or rotational fashion in relation to a 3-D image;

FIG. 7 shows a flowchart for illustrating a preferred embodiment of the method according to the disclosure; and

FIG. 8 shows a motor vehicle having the apparatus.

### DETAILED DESCRIPTION

Throughout the figures, the same reference signs are used for the same or corresponding elements of the invention.

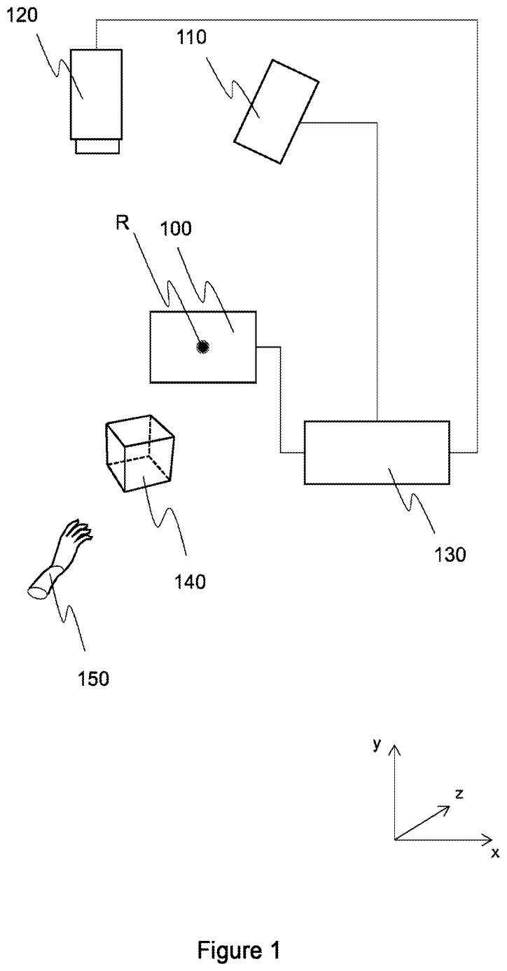

FIG. 1 schematically shows an apparatus according to a first exemplary embodiment, having a first projection device 120. The apparatus comprises a display device 100, an acquisition device 110, the first projection device 120 and an evaluation device 130. A 3-D image 140, which represents a cube, is displayed by the display device 100. In particular, this can be an autostereoscopic or holographic 3-D image. On the part of a user, this type of presentation requires no additional auxiliary means by means of which the 3-D image 140 is rendered perceivable. However, this can also be a presentation of a 3-D image 140 which requires auxiliary means, for example 3-D glasses, for the perception thereof.

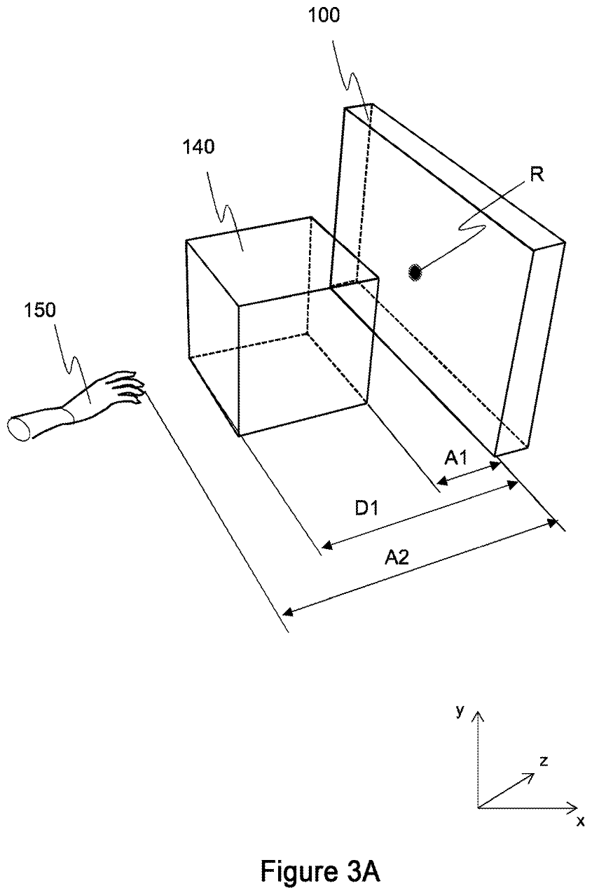

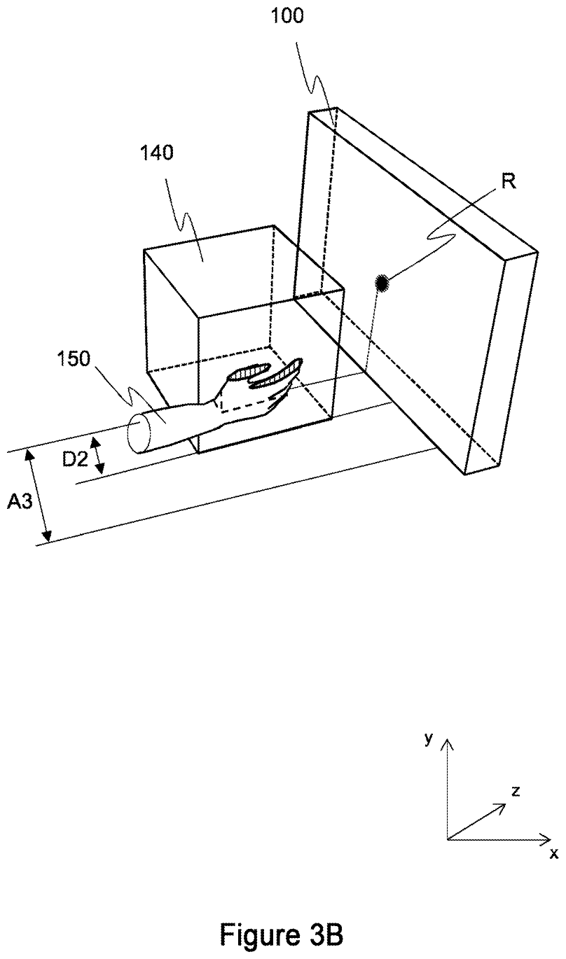

The display device 100 may comprise an electronic visual display, by means of which the 3-D image 140 is presented. In relation to the schematically depicted coordinate system with coordinate axes x, y and z, the display device 100, the 3-D image 140 and a hand 150 of the user are arranged substantially along the z-axis. In this case, the 3-D image 140 is presented at a first distance A1 from a reference position R formed centrally on a surface of the display device 100 facing the 3-D image 140. The reference position R can be described by three coordinates (x, y, z), corresponding to the coordinate system presented. In this case, distances from this reference position may relate to one of the coordinates (x, y, z). A presentation of the first distance A1, and of further distances such as a second distance A2, a third distance A3, a first minimum distance D1 and a second minimum distance D2, is shown in FIG. 3A and FIG. 3B, especially in relation to the reference position R. The first distance A1 is determined by the presentation of the 3-D image 140 by way of the display device 100. In particular, the first distance A1 can be understood to mean the shortest distance between the display device 100 and the 3-D image 140. A user can perceive the 3-D image 140 from a suitable viewing position. Below, the user is assumed to have adopted the corresponding viewing position. From this viewing position, the user can reach the 3-D image 140 with their hand 150, or else with an object held in the hand 150.

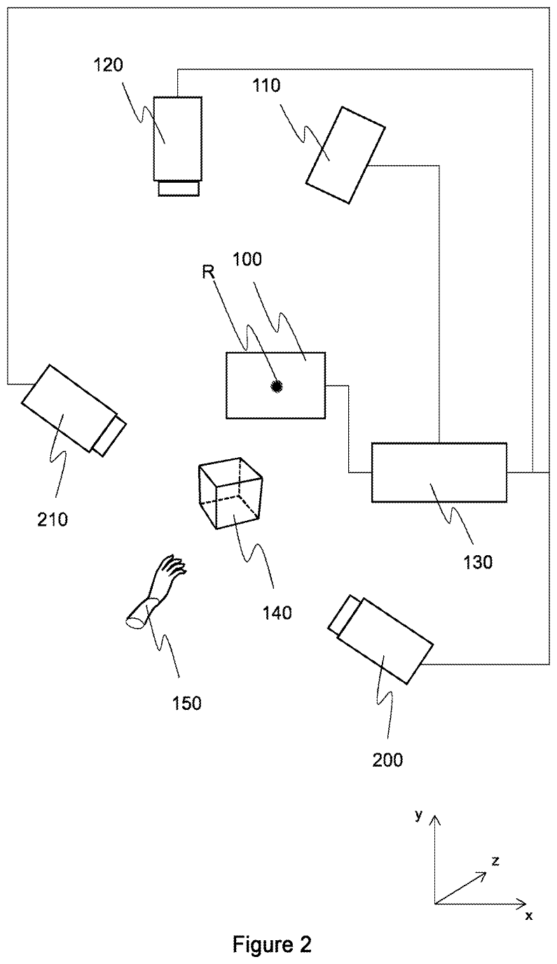

According to FIG. 1, and also FIG. 2, the 3-D image 140 is arranged axially between the display device 100 and the hand 150. In this case, the hand 150 is spaced apart from the display device 100 at a second distance A2. The hand 150 is movable. Therefore, the second distance A2 should be understood to mean a current distance in each case.

A spatial region in the surroundings of the 3-D image 140 can be captured in real time by the acquisition device 110. In particular, the acquisition device 110 can comprise a 3-D camera system with a 3-D image sensor in which the known time-of-flight method is used. Likewise, captures or measurements by the acquisition device 110 can be implemented on the basis of other technologies, for instance optical image analysis, radar or capacitive measurements. Other measuring techniques for constructing captured surroundings are also conceivable. These may include imaging methods capable of reconstructing a scene by machine learning. The acquisition device 110 captures at least the display device 100 and the hand 150. The second distance A2 is determined using the captured data in relation to the display device 100 and the hand 150. The second distance A2 becomes smaller when the hand 150 moves in the direction of the 3-D image 140, and hence in the direction of the display device 100.

A first optical display, i.e. an optical signal, can be projected onto the hand 150 by the projection device 120. In FIG. 1, the projection device 120 is arranged such that a projection is implemented substantially parallel to the surface of the display device 100 that faces the 3-D image 140. However, it is likewise conceivable for the projection to be implemented obliquely, i.e. at an angle in relation to the arrangement shown. In relation to the schematically depicted coordinate system, the projection is implemented substantially in the direction along the y-axis. The projection device 120 can comprise a projector based on digital light processing, also known as a DLP projector. The projection device 120 can comprise a laser, in particular using a MEMS (microelectromechanical system). Likewise, the projection device 120 may comprise a liquid crystal electronic visual display, which is also known under the abbreviation LCOS and at which light is reflected. The projection by the projection device 120 is triggered by the evaluation device 130.

The evaluation device 130 comprises a computer with a computer program, wherein the computer is signal-connected to the projection device 120, the acquisition device 110 and the display device 100. As a result, the computer or computer program can carry out calculations on the basis of signals obtained or on the basis of information from the projection device 120, the acquisition device 110 and/or the display device 100. Furthermore, the computer can transmit signals, for example to the projection device 120, in order to trigger a projection. In this case, a projection of the first optical display by the projection device 120 is triggered should the determined second distance A2 be less than a first minimum distance D1 defined in advance. This first minimum distance D1 defined in advance can be chosen such that the hand 150 is adjacent to an outer region of the 3-D image 140 or grasps into the 3-D image 140 when said first minimum distance is undershot by the hand 150. In this case, there is a projection of the first optical display, whereby an interaction of the hand 150 with the 3-D image is visualized. For the purpose of determining the first minimum distance D1, it is conceivable that a user whose hand 150 approaches the 3-D image 140 stores a calibration position of their hand 150 in the evaluation device 130, in which calibration position the hand 150 experiences contact with the outer region of the 3-D image 140 from the view of the user. During future movements of the hand 150, the evaluation device 130 can compare the respective current position of the hand 150, or the respective assignable second distance A2, with the first minimum distance D1. The provision of a calibration position in the interior of the 3-D image 140 is also conceivable.

FIG. 2 schematically shows an apparatus according to a second exemplary embodiment, having three projection devices. In addition to the first projection device 120, the apparatus comprises a second projection device 200 and a third projection device 210 in this second exemplary embodiment. As a result of this second projection device 200 and the third projection device 210, a second optical display and a third optical display can additionally be projected onto the hand 150 by the second projection device 200 and the third projection device 200, respectively. By preference, the first projection device 120, the second projection device 200 and the third projection device 210 are arranged relative to one another such that the projections are implemented from different directions. This allows the optical displays to be projected from different directions and onto different regions of the hand 150. As a result, the interaction of the hand 150 with the 3-D image 140 can be presented even better.

FIGS. 3A and 3B schematically show a 3-D presentation of a hand 150, a 3-D image 140 and display device 100 in each case.

In this case FIG. 3A depicts the 3-D image 140 axially between the hand 150 and the display apparatus 100, as per FIG. 1. The second distance A2 is a distance between a reference position R formed centrally on a surface of the display apparatus 100 facing the 3-D image 140 and the hand 150. At least the display device 100 and the hand 150 can be captured by the acquisition device 110. In this case, the evaluation device 130 stores the reference position R in relation to the display apparatus 100. The respective second distance A2 is determined using the captured data of the display device 100 and of the hand 150. The second distance A2 reduces should the hand 150 move in the direction of the 3-D image 140, and hence in the direction of the display device 100. A projection is triggered should the second distance A2 reach or drop below a specified first minimum distance D1.

According to FIG. 3B, the hand 150 is arranged to the side of the 3-D image 140. Here, a third distance A3 is depicted between the display device 100 and a side face of the 3-D image 140. Accordingly, a projection can be triggered should the hand 150 approach the 3-D image 140 from the side and drop below a second minimum distance D2.

It is likewise conceivable that the 3-D image 140 is arranged between two hands by the inclusion of a further hand. Should appropriate evaluations of the third distance A3 and optionally of a further distance, which represents a distance between the further hand and a further side face, yield that the 3-D image 140 is contacted by both hands, there can be a corresponding projection onto both hands in order to visualize this contact. Furthermore, it is conceivable that a movement of the 3-D image 140 is initiated by a movement of the two hands (this is not shown here).

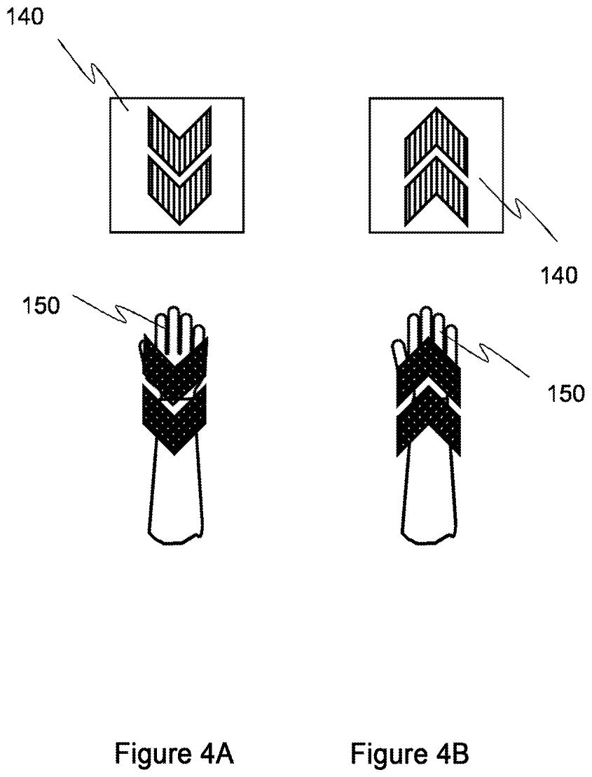

FIGS. 4A and 4B schematically show a hand 150 in each case, which accordingly moves toward (FIG. 4B) or away from (FIG. 4A) a 3-D image 140. In the process, moving directional arrows are projected onto the hand 150 in each case. According to FIG. 4A, the directional arrows point away from the 3-D image 140. In this case, the directional arrows are depicted both on a back of the hand and in the 3-D image 140. According to FIG. 4B, the directional arrows on the back of the hand point toward the 3-D image 140 and additional directional arrows which point in the same direction are depicted in the 3-D image 140. Object data of the hand 150 can be captured in real time by the acquisition device 110, i.e. the 3-D camera system for example. A movement direction of the hand can also be determined thereby. The evaluation device 130 can trigger a projection in which an optical display comprises a moving display that represents a movement direction. A comparable presentation with moving directional arrows in the 3-D image 140 can be triggered by the evaluation device 130 by way of the signal-connection of the evaluation device 130 to the display device 100.

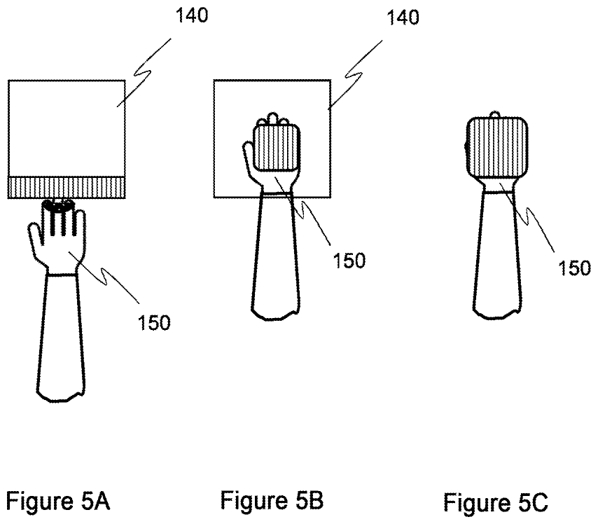

FIGS. 5A to 5C schematically show an overlap of a hand 150 with a 3-D image 140, in each case to a different extent of the area of said hand. In FIG. 5A, fingers of the hand 150 are in contact with an outer region of the 3-D image 140. Accordingly, an optical display is projected onto the fingertips. In FIG. 5B, the hand 150 is situated completely within the 3-D image 140. In the process, the optical display is projected onto the hand 150. In FIG. 5C, the hand 150 is likewise situated completely within the 3-D image 140. In addition to the projection of the optical display onto the hand 150, the 3-D image 140 is masked. Interactions or differently sized regions of overlap of the hand 150 with the 3-D image 140 are visualized by way of these different projected optical displays on the hand 150.

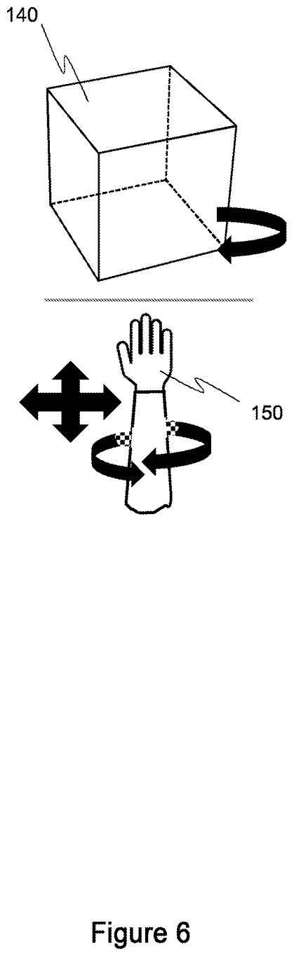

FIG. 6 schematically shows a hand 150 which can move in translational and/or rotational fashion in relation to a 3-D image 140. This is indicated by the depicted directional arrows. In this case, the presentation of the 3-D image 140 is changed as a result of the movement of the hand 150. For example, turning the hand 150 might lead to a rotation of the 3-D image 140. This can be achieved by virtue of the acquisition device 110 capturing object data of the hand 150 in real time, and this for example rendering possible a determination as to whether the hand 150 is turning. If the hand 150 is turning, a rotation of the 3-D image 140 by the display device 100 can be triggered by the evaluation unit 130.

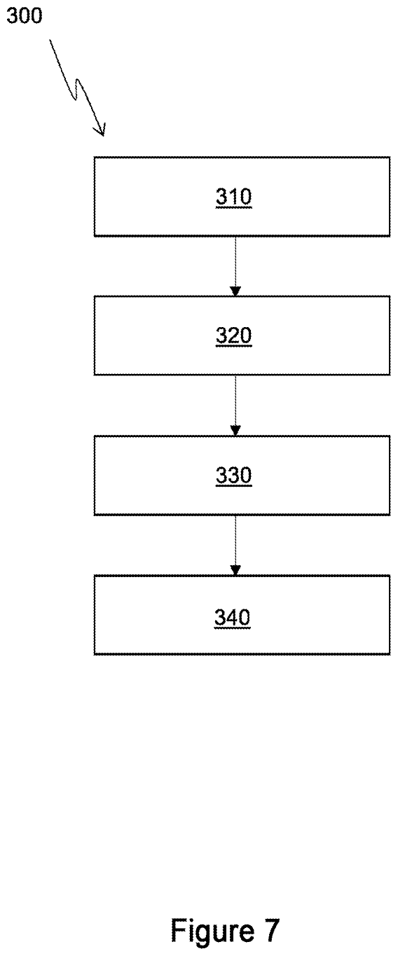

FIG. 7 is a flowchart 300 for illustrating a preferred embodiment of a method for visualizing an interaction of a physical object 150 with a 3-D image 140.

The 3-D image 140 is presented by a display device (100) in a first step 310 of the method, wherein the 3-D image (140) is perceivable by a user.

In a further step 320 of the method, there is a capture of first object data of the display device 100 and second object data of the physical object 150 that is spaced apart from the display device 100 and movable.

In a further step 330 of the method, there is a determination of a second distance A2 and/or a third distance A3 between a reference position R formed on a surface of the display device 100 and the physical object 150 using the first object data and the second object data.

In a further step 340 of the method, there is a projection of a first optical display onto a first region of the physical object 150 should the determined second distance A2 and/or the determined third distance A3 be less than a first minimum distance D1 or second minimum distance D2 defined in advance.

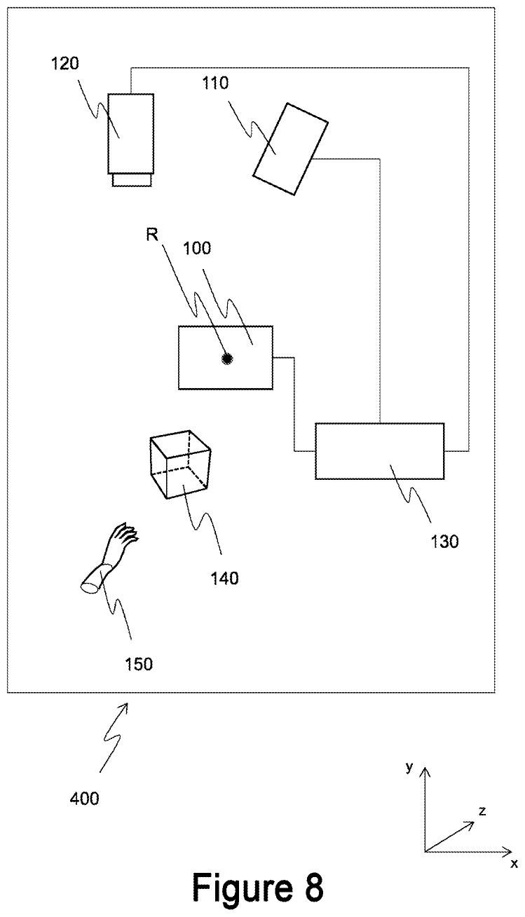

FIG. 8 schematically shows a motor vehicle 400 having the apparatus as described above in accordance with the first exemplary embodiment of FIG. 1. The motor vehicle 400 can likewise comprise the apparatus according to the second exemplary embodiment of FIG. 2.

While at least exemplary embodiment has been described above, it should be observed that there are a large number of variations in this respect. It should also be observed here that the described exemplary embodiments constitute only non-limiting examples and they are not intended to limit the scope, applicability or configuration of the apparatuses and methods described here. Instead, the above description will provide a person skilled in the art with an indication for the implementation of at least one exemplary embodiment, wherein it is understood that various changes in the manner of functioning and the arrangement of the elements described in an exemplary embodiment can be made without departing here from the subject matter which is respectively defined in the appended claims or its legal equivalents.

### LIST OF REFERENCE SIGNS

100 Display device
110 Acquisition device
120 First projection device
130 Evaluation device
140 3-D image
150 Hand
200 Second projection device
210 Third projection device
300 Flowchart for illustrating a preferred embodiment of the inventive
310 representation of 3-D image
320 capture
330 determination of a second distance
340 projection
400 Motor vehicle
A1, A2, A3 First, second and third distance
D1, D2 First and second minimum distance

1.-11. (canceled)

12. An apparatus for visualizing an interaction of a physical object with a 3-D image, comprising:
a display device configured to present the 3-D image which is perceivable by a user;
a first projection device configured to project a first optical display onto a first region of the physical object;
an acquisition device configured to capture first object data of the display device and second object data of the physical object that is spaced apart from the display device and movable, the acquisition device configured to determine a distance between a reference position formed on a surface of the display device and the physical object using the first object data and the second object data; and
an evaluation device is signal-connected to the acquisition device and the first projection device, the evaluation device configured to trigger the projection of the first optical display by the first projection device responsive to a condition in which the determined distance is less than a minimum distance defined in advance.

13. The apparatus as claimed in claim 12, wherein the acquisition device is configured to determine the distance continually in real time.

14. The apparatus as claimed in claim 13, wherein the evaluation device is configured to determine a movement direction of the physical object in relation to the display device in real time using the continually determined distance, and wherein the first optical display represents the movement direction of the physical object.

15. The apparatus as claimed in claim 14, wherein the evaluation device is configured to trigger the projection of the first optical display, representing the movement direction, continually over a predetermined time interval, wherein the first optical display changes over the predetermined time interval.

16. The apparatus as claimed in claim 15, wherein the acquisition device is configured to determine a rotational position of the physical object in relation to an initial position, defined in advance, using the second object data of the physical object and trigger, on the basis of the rotational position, the presentation of the first optical display.

17. The apparatus as claimed in claim 14, wherein the acquisition device is configured to determine a rotational position of the physical object in relation to an initial position, defined in advance, using the second object data of the physical object and trigger, on the basis of the rotational position, the presentation of the first optical display.

18. The apparatus as claimed in claim 12, wherein the acquisition device is configured to determine a rotational position of the physical object in relation to an initial position, defined in advance, using the second object data of the physical object and trigger, on the basis of the rotational position, the presentation of the first optical display.

19. The apparatus as claimed in claim 18, wherein the acquisition device is signal-connected to the display device, and wherein the acquisition device is configured to trigger, on the basis of the determined distance or the rotational position of the physical object, a change in the presentation of the 3-D image by the display device.

20. The apparatus as claimed in claim 19, wherein the acquisition device is configured to trigger, on the basis of the determined movement direction of the physical object, a change in the presentation of the 3-D image by the display device.

21. The apparatus as claimed in claim 18, wherein the acquisition device is configured to trigger, on the basis of the determined movement direction of the physical object, a change in the presentation of the 3-D image by the display device.

22. The apparatus as claimed in claim 17, wherein the acquisition device is configured to trigger, on the basis of the determined movement direction of the physical object, a change in the presentation of the 3-D image by the display device.

23. The apparatus as claimed in claim 22, wherein the display device is configured to present the 3-D image in autostereoscopic or holographic format.

24. The apparatus as claimed in claim 18, wherein the display device is configured to present the 3-D image in autostereoscopic or holographic format.

25. The apparatus as claimed in claim 12, wherein the display device is configured to present the 3-D image in autostereoscopic or holographic format.

26. The apparatus as claimed in claim 12, further comprising a second projection device configured to project a second optical display onto a second region of the physical object, wherein the evaluation device is configured to trigger the second projection should the determined distance be less than the minimum distance defined in advance.

27. A motor vehicle, comprising an apparatus as claimed in claim 12.

28. A method for visualizing an interaction of a physical object with a 3-D image, the method comprising:
presenting the 3-D image using a display device, wherein the 3-D image is perceivable by a user;
capturing first object data of the display device and second object data of the physical object that is spaced apart from the display device and movable,
determining a distance between a reference position formed on a surface of the display device and the physical object using the first object data and the second object data; and
projecting an optical display onto a region of the physical object responsive to a condition that the determined distance is less than a minimum distance defined in advance.
